(19) United States
(12) Patent Application Publication
(10) Pub. No.: US 2009/0184703 A1
(43) Pub. Date: Jul. 23, 2009

(54) VOLTAGE COMPENSATOR FOR DUAL-SECONDARY VOLTAGE TRANSFORMERS

(75) Inventor: Glenn Warren Larson, Terry, MS (US)

Correspondence Address: HARNESS, DICKEY & PIERCE, P.L.C., P.O. BOX 828, BLOOMFIELD HILLS, MI, 48303, US

(73) Assignee: Kuhlman Electric Corporation

(21) Appl. No.: 12/015,717

(22) Filed: Jan. 17, 2008

(51) Int. Cl. H01F 27/42

(52) U.S. Cl. 323/356

(57) ABSTRACT

An compensated voltage transformer includes a voltage transformer. The voltage transformer includes a primary winding that receives a supply voltage, a meter winding that generates a first voltage based on a first turns ratio between the primary winding and the meter winding, and a power winding that generates a second voltage based on a second turns ratio of the primary winding to the power winding. A current transformer includes a primary winding and a secondary winding. The primary winding carries a load current that flows through the power winding and the secondary winding connects to the meter winding.

### FIELD

The present disclosure relates to voltage compensation circuits for multi-secondary voltage transformers.

### BACKGROUND

The statements in this section merely provide background information related to the present disclosure and may not constitute prior art.

Dual-secondary voltage transformers can be used for metering in high-voltage circuits. A supply voltage can be applied to a primary winding of the transformer and indirectly measured via one of the secondary windings, i.e. a meter winding. The other secondary winding provides power to a load. An output of the meter winding may be coupled to at least one of metering and protective relay equipment.

### SUMMARY

A compensated voltage transformer includes a voltage transformer. The voltage transformer includes a primary winding that receives a supply voltage, a meter winding that generates a first voltage based on a first turns ratio between the primary winding and the meter winding, and a power winding that generates a second voltage based on a second turns ratio of the primary winding to the power winding. A current transformer includes a primary winding and a secondary winding. The primary winding carries a load current that flows through the power winding and the secondary winding connects to the meter winding.

In other features a compensation impedance connects across the secondary winding. The compensation impedance generates a compensation voltage that is summed with a meter voltage which is generated by the meter winding. The compensation impedance comprises a resistance and a reactance. The resistance and the reactance are connected in series.

An compensated voltage transformer includes a voltage transformer that includes a primary winding that receives a supply voltage, a meter winding that generates a first voltage based on a first turns ratio between the primary winding and the meter winding, and a power winding that generates a second voltage based on a second turns ratio of the primary winding to the power winding. A current transformer includes a primary winding that connects to the power winding and a secondary winding that connects to the meter winding. A compensation impedance connects across the secondary winding of the current transformer. The compensation impedance generates a voltage that is summed with the first voltage to provide a metering voltage.

In other features the compensation impedance comprises a resistance and a reactance. The resistance and the reactance are connected in series. The excitation impedance comprises a resistance and an inductive reactance. The resistance and the inductive reactance are provided by a resistor and an inductor, respectively, which are connected in parallel across the voltage transformer primary winding. The meter winding and the power winding have unequal numbers of turns.

A method of compensating a meter voltage in a voltage transformer includes applying a supply voltage to a primary winding of a voltage transformer, providing a load current from a first secondary winding of the voltage transformer to a load, generating a first voltage across a second secondary winding of the voltage transformer, transforming the load current to a second current, generating a second voltage based on the second current, and summing the first voltage and the second voltage to generate a meter voltage that is based on the supply voltage and the load current.

In other features generating the second voltage includes passing the second current through an impedance. The method includes matching an input impedance of the primary winding to a source impedance of the supply voltage.

A compensation circuit for a multi-secondary voltage transformer includes a current transformer and an impedance. The current transformer includes a primary winding for connecting to a first secondary winding of a multi-secondary voltage transformer and a secondary winding for connecting to second secondary winding of the multi-secondary voltage transformer. The impedance conducts current of the current transformer secondary winding and thereby drops a compensation voltage. The compensation voltage is proportional to a voltage drop of a primary winding of the multi-secondary voltage transformer.

In other features the current transformer primary winding conducts a load current of the multi-secondary voltage transformer. The compensation impedance comprises a resistance and a reactance. The compensation impedance comprises a resistor and an inductor.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of compensated voltage transformer;

FIG. 2 is a phasor diagram of the compensated voltage transformer; and

FIG. 3 is an enlarged view of a right-hand plane of the phasor diagram of FIG. 2.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

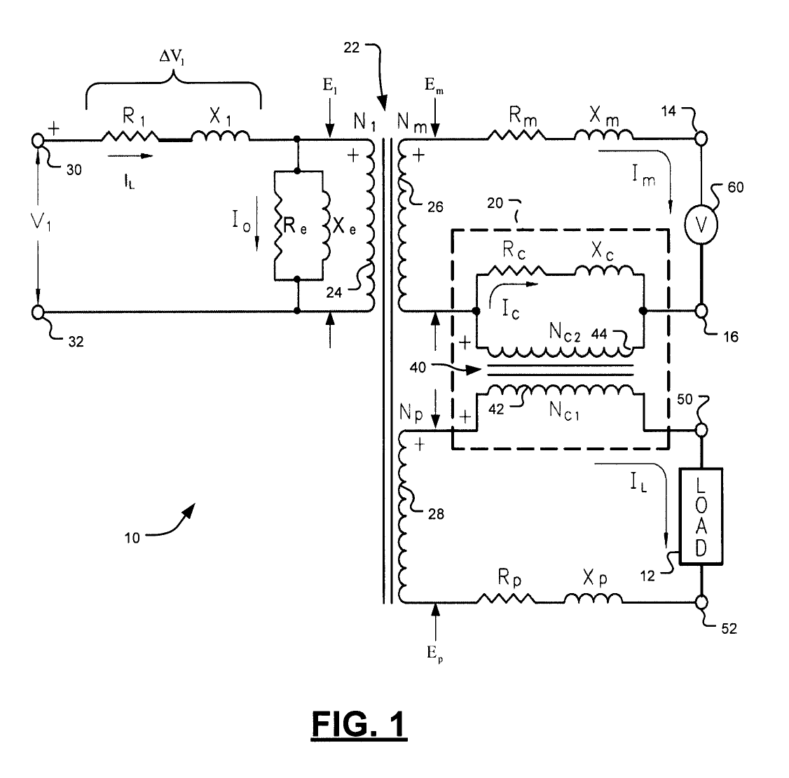

Referring now to FIG. 1, a schematic diagram is shown of a compensated voltage transformer 10. A voltage compensator 20 is a passive device that is used in conjunction with a dual secondary voltage transformer 22. It should also be noted, however, that unusual variations of this concept is also possible where voltage transformers with more than two secondaries could be involved. In the following description, however, it shall be assumed that the voltage transformer involved has two secondaries 26, 28.

Voltage compensator 20 maintains a constant voltage of metering consistency on secondary winding 26 while simultaneously providing power from secondary winding 28. Under perfect conditions, the voltage at the metering winding, i.e., secondary winding 26, should be unaffected by any load on the power winding, i.e. secondary winding 28, up to a rated maximum.

Any change that may occur in the metering winding, as a result of the load across the power winding, would be due to misalignment of the compensating voltage referred to as drift.

Voltage compensator 20 basically consists of a current transformer 40 with its secondary connected across a compensation impedance. The primary of current transformer 40 is connected in series with the power winding and the impedance is connected in series with the metering winding. The current from the power winding is stepped down by the current transformer and fed through the compensation impedance.

This compensation impedance, in conjunction with current transformer 40, replicates the reflected primary voltage drop incurred by the power load, both in phase and in magnitude.

It is this compensating voltage, which is aligned to characteristics of voltage transformer 22, that restores the metering voltage to its original level.

Transformer 22 is shown as having two secondary windings; however it should be appreciated that it may have more. Compensated voltage transformer 10 includes multi-secondary voltage transformer 22. Transformer 22 includes a primary winding 24 that receives a supply voltage V₁, a secondary winding 26 that generates an uncompensated metering voltage, and a secondary winding 28 that provides a voltage to a load 12. Compensated voltage transformer 10 also provides a metering voltage across output nodes 14 and 16. A voltage compensator 20 generates a compensation voltage (V_{C}) that is added to the uncompensated metering voltage. The compensation voltage V_{C} compensates for a voltage ΔV₁ that is dropped across primary winding 24. The compensation voltage V_{C} is based on a load current I_{L}. The sum is a compensated metering voltage that is taken across nodes 14 and 16. The compensated metering voltage represents the supply voltage V with greater accuracy than an uncompensated transformer would.

Voltage compensator 20 improves metering accuracy from secondary winding 26 while second secondary winding 28 delivers power to load 12. The power output of the secondary winding 28 can range from zero up to and beyond a rating of transformer 22, depending upon a saturation of a current transformer 40 that is included in voltage compensator 20. Voltage compensator 20 works with secondary windings 26 and 28 that have the same or different turns ratios. An impedance of voltage compensator 20 in the metering voltage circuit reduces the maximum burden that can be sustained for a given accuracy. In some implementations burdens up to and including Y provide the best accuracy when voltage compensator 20 is employed.

Transformer 22 includes primary winding 24, first secondary or meter winding 26, and second secondary or power winding 28. Primary winding 24 has N₁ turns. Meter winding 26 has Nₘ turns. Power winding 28 has Nₚ turns. Nₘ can be equal to Nₚ.

The supply voltage V₁ is applied to input nodes 30 and 32. A resistance R₁ and reactance X₁ represent a resistance and reactance of primary winding 24. Input node 30 communicates with one end of resistance R₁. A second end of resistance R₁ communicates with a first end of reactance X₁. A second end of reactance X₁ communicates with a first end of primary winding 24. A second end of primary winding 24 communicates with input node 32. A resistance Rₑ and a reactance Xₑ are in parallel with primary winding 24 and represent an excitation impedance of primary winding 24.

Voltage compensator 20 includes current transformer 40. Current transformer 40 includes a primary winding 42 and secondary winding 44. Primary winding 42 has N_{C1} turns. Secondary winding 44 has N_{C2} turns. A first end of secondary winding 44 communicates with a first end of a resistance R_{C}. The first end of primary winding 42 is in phase with the first end of secondary winding 44. A second end of resistance R_{C} communicates with a first end of a reactance X_{C}. A second end of reactance X_{C} communicates with a second end of secondary winding 44. Resistance R_{C} and reactance X_{C} comprise the compensation impedance.

A first end of meter winding 26 communicates with a first end of a resistance Rₘ. The first end of meter winding 26 is in phase with the first end of primary winding 24. A second end of resistance Rₘ communicates with a first end of a reactance Xₘ. A second end of reactance Xₘ communicates with node 14. A second end of meter winding 26 communicates with the first end of secondary winding 44 and the first end of the compensation impedance.

A first end of power winding 28 communicates with first end of primary winding 42. The first end of power winding 28 is in phase with the first end of primary winding 24. A second end of primary winding 42 communicates with an output node 50. A second end of power winding 28 communicates with one end of a resistance Rₚ. A second end of resistance Rₚ communicates with a first end of a reactance Xₚ. A second end of reactance Xₚ communicates with a node 52. Nodes 50 and 52 provide power to load 12. Resistance Xₚ and reactance Xₚ represent the resistance and reactance, respectively, of power winding 28.

A circuit analysis of compensated voltage transformer 10 will now be described. The analysis assumes that currents Iₒ and Iₘ are negligible and therefore equal to zero. Iₒ is the total current flowing through the excitation impedance. Iₘ is a current flowing through a metering module 60 that connects across nodes 14 and 16. Metering module 60 includes a high input impedance and indicates and/or reacts to the metering voltage.

A primary load current I′_{L} is provided by

$${I}_{L}^{′} = ( \frac{{N}_{p}}{{N}_{1}} ) {I}_{L} , \qquad ( Eq . 1 )$$

Where I_{L} is the current through load 12. I_{L} for a given KVA can be estimated by I_{L}=KVA/Vₚ. A primary resistive drop V_{R1} is a voltage dropped across resistor R₁ and is provided by

$${V}_{R 1} = {I}_{L}^{′} {R}_{1} = ( \frac{{N}_{p}}{{N}_{1}} ) {I}_{L} {R}_{1} . \qquad ( Eq . 2 )$$

Voltage V_{R1} reflected to meter winding 26 is V′_{R1} and is provided by

$${V}_{R 1}^{′} = ( \frac{{N}_{m}}{{N}_{1}} ) {V}_{R 1} \\ {V}_{R 1}^{′} = ( \frac{{N}_{m}}{{N}_{1}} ) ( \frac{{N}_{p}}{{N}_{1}} ) {I}_{L} {R}_{1} \\ {V}_{R 1}^{′} = ( \frac{{N}_{m} {N}_{p}}{{N}_{1}^{2}} ) {I}_{L} {R}_{1} \qquad ( Eq . 3 )$$

Similarly, a primary voltage drop across reactance X₁ is provided by

$${V}_{X 1}^{′} = ( \frac{{N}_{m} {N}_{p}}{{N}_{1}^{2}} ) {I}_{L} {X}_{1} . \qquad ( Eq . 4 )$$

Load current I_{L} reflects back into primary winding 24 as I′_{L} according to the turns ratio Nₚ/N₁. The reflected current produces a voltage drop across resistance R₁ and reactance X₁ and that is reflected into metering winding 26 as V′_{R1} and V′_{X1} according to the turns ratio Nₘ/N₁. Voltage compensator 20 recreates V′_{R1} and V′_{X1} via a compensating current I_{C} that flows through the compensation impedance. The voltages are added to the voltage of meter winding 26 to produce the metering voltage that appears across nodes 14 and 16. That is,

V′_{R1}=I_{C}R_{C} and V′_{X1}=I_{C}X_{C} (Eq. 5)

The compensator current I_{C} is provided by

$$\begin{matrix}{I}_{C} = ( \frac{{N}_{C 1}}{{N}_{C 2}} ) {I}_{L} & ( Eq . 6 ) \\ {V}_{R 1}^{′} = ( \frac{{N}_{C 1}}{{N}_{C 2}} ) {I}_{L} {R}_{C} & ( Eq . 7 )\end{matrix}$$

### From Eq. 3,

$$\begin{matrix}{V}_{R 1}^{′} = ( \frac{{N}_{m} {N}_{p}}{{N}_{1}^{2}} ) {I}_{L} {R}_{1} \\ ( \frac{{N}_{C 1}}{{N}_{C 2}} ) {I}_{L} {R}_{C} = ( \frac{{N}_{m} {N}_{p}}{{N}_{1}^{2}} ) {I}_{L} {R}_{1} \\ ( \frac{{N}_{C 1}}{{N}_{C 2}} ) {R}_{C} = ( \frac{{N}_{m} {N}_{p}}{{N}_{1}^{2}} ) {I}_{L} {R}_{1} & ( Eq . 3 ) \\ {R}_{C} = ( \frac{{N}_{C 1}}{{N}_{C 2}} ) ( \frac{{N}_{m} {N}_{p}}{{N}_{1}^{2}} ) {R}_{1} . & ( Eq . 8 )\end{matrix}$$

### Similarly,

$${X}_{C} = ( \frac{{N}_{C 1}}{{N}_{C 2}} ) ( \frac{{N}_{m} {N}_{p}}{{N}_{1}^{2}} ) {X}_{1} . \qquad ( Eq . 9 )$$

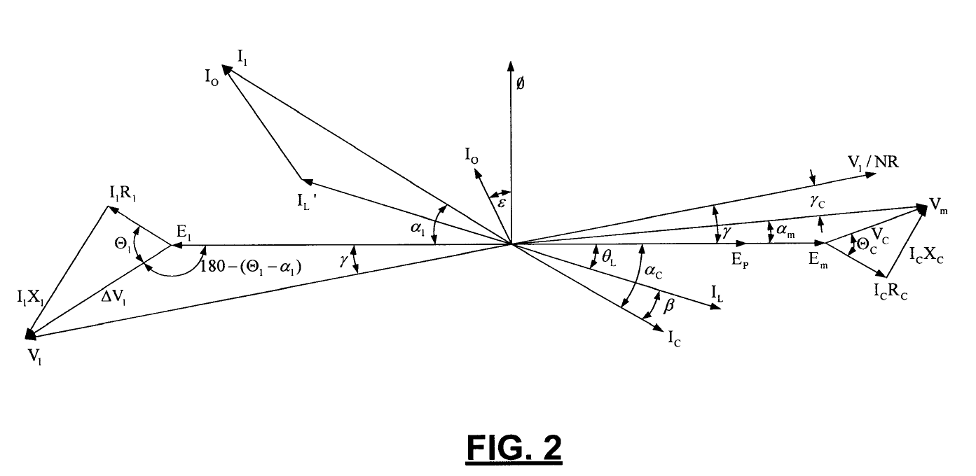

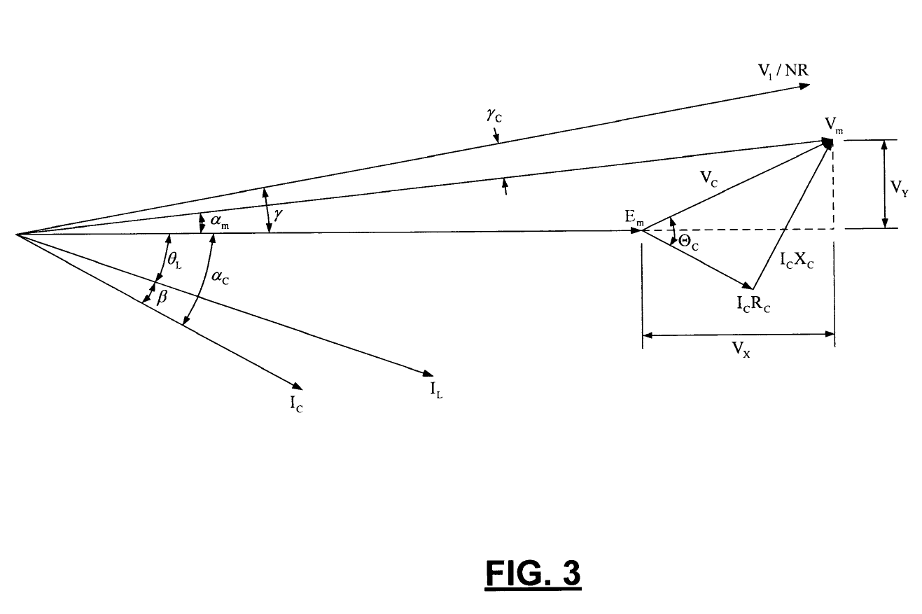

Referring now to FIGS. 2-3, a further circuit analysis is provided that includes phase relationships between electrical signals in compensated voltage transformer 10. Again, it is assumed the metering current Iₘ is zero.

An error voltage ΔV₁, which voltage compensator 20 tries to eliminate, is a result of a voltage drop across the primary impedance incurred by the primary current I₁. The primary impedance consists of the series combination resistance R₁ and reactance X₁. Primary current I₁ includes reflected load current I_{L} together with the excitation current I_{O}.

I₁=\sqrt{(I′_{L} cos Θ_{L}+Iₒ sin ε)²+(I_{L} sin Θ_{L}+Iₒ cos ε)²}, and (Eq. 10)

$${α}_{1} = arctan [ \frac{{I}_{L}^{′} sin {Θ}_{L} + {I}_{o} cos ɛ}{{I}_{L}^{′} cos {Θ}_{L} + {I}_{o} sin ɛ} ] , where \\ {Θ}_{L} = arctan ( \frac{{X}_{1}^{′} + {X}_{p} + {X}_{L} + {( {N}_{C 1} / {N}_{C 2} )}^{2} {X}_{C}}{{R}_{1}^{′} + {R}_{p} + {R}_{L} + {( {N}_{C 1} / {N}_{C 2} )}^{2} {R}_{C}} ) . \qquad ( Eq . 11 )$$

The error voltage is provided by

ΔV₁=I₁Z₁. (Eq. 12)

To derive an accuracy of compensated voltage transformer 10, the accuracy of compensated voltage transformer 10 without compensation can be calculated first. That is, one may first calculate the voltage Eₘ and its relationship with respect to magnitude and phase to V′₁. E₁ needs to be derived to calculate Eₘ. E₁ can be calculated using the law of cosines as follows:

$$\begin{matrix}{V}_{1}^{2} = Δ {V}_{1}^{2} + {E}_{1}^{2} - 2 Δ {V}_{1} {E}_{1} cos [ 180 - ( {Θ}_{1} - {α}_{1} ) ] \\ = Δ {V}_{1}^{2} + {E}_{1}^{2} - 2 Δ {V}_{1} {E}_{1} [ - cos ( {Θ}_{1} - {α}_{1} ) ] \\ = Δ {V}_{1}^{2} + {E}_{1}^{2} + 2 Δ {V}_{1} {E}_{1} cos ( {Θ}_{1} - {α}_{1} )\end{matrix}$$

### Re-arranging,

E₁²+2ΔV₁ cos(Θ₁−α₁)E₁+ΔV₁²−V₁²=0.

Solving for a quadratic equation:

$$\begin{matrix}{E}_{1} = \frac{\begin{matrix}- ( 2 Δ {V}_{1} cos ( {Θ}_{1} - {α}_{1} ) ) \pm \\ \sqrt{{[ 2 Δ {V}_{1} cos ( {Θ}_{1} - {α}_{1} ) ]}^{2} - 4 ( 1 ) ( Δ {V}_{1}^{2} - {V}_{1}^{2} )}\end{matrix}}{2 ( 1 )} \\ = \frac{\begin{matrix}- 2 Δ {V}_{1} cos ( {Θ}_{1} - {α}_{1} ) \pm \\ \sqrt{4 Δ {V}_{1}^{2} {cos}^{2} ( {Θ}_{1} - {α}_{1} ) - 4 ( Δ {V}_{1}^{2} - {V}_{1}^{2} )}\end{matrix}}{2} \\ = - Δ {V}_{1} cos ( {Θ}_{1} - {α}_{1} ) \pm \sqrt{Δ {V}_{1}^{2} {cos}^{2} ( {Θ}_{1} - {α}_{1} ) - Δ {V}_{1}^{2} + {V}_{1}^{2}} \\ = Δ {V}_{1} cos ( {α}_{1} - {Θ}_{1} ) \pm \sqrt{Δ {V}_{1}^{2} {cos}^{2} ( {Θ}_{1} - {α}_{1} ) - Δ {V}_{1}^{2} + {V}_{1}^{2}} ,\end{matrix} \\ where {Θ}_{1} = arctan ( \frac{{X}_{1}}{{R}_{1}} ) \qquad ( Eq . 13 )$$

Knowing E₁, Eₘ can be derived from the volts per turn:

$${E}_{m} = ( \frac{{E}_{1}}{{N}_{1}} ) {N}_{m} . \qquad ( Eq . 14 )$$

A ratio correction factor (RCF) is the primary terminal voltage V₁ divided by the nominal ratio over Eₘ. That is,

RCF=(V₁/NR)/Eₘ (Eq. 15)

V₁/NR is a true reference metering voltage against which actual metering voltages, compensated and uncompensated, can be measured with respect to ratio correction factor and phase angle error. It is a theoretical ideal and should not be mistaken for the reflected primary voltage V₁′=V₁ (Nₘ/N₁).

Calculating the phase angle error in the absence of voltage compensator 20 will now be described. Referring to the phasor diagrams of FIGS. 2-3, phase angle γ can be derived using the law of cosines.

$$Δ {V}_{1}^{2} = {V}_{1}^{2} + {E}_{1}^{2} - 2 {V}_{1} {E}_{1} cos γ \\ 2 {V}_{1} {E}_{1} cos γ = {V}_{1}^{2} + {E}_{1}^{2} - Δ {V}_{1}^{2} \\ cos γ = \frac{( {V}_{1}^{2} + {E}_{1}^{2} - Δ {V}_{1}^{2} )}{2 {V}_{1} {E}_{1}} \\ γ = arccos ( \frac{{V}_{1}^{2} + {E}_{1}^{2} - Δ {V}_{1}^{2}}{2 {V}_{1} {E}_{1}} ) \qquad ( Eq . 16 )$$

Current transformer 40 provides the compensating current I_{C} that flows through the compensating impedance, e.g. resistance R_{C} and reactance X_{C}, to produce the compensation voltage V_{C}. The load current I_{L} of power winding 28 is the effective current through primary winding 42 of current transformer 40. It may be assumed that the burden of metering device 60 is a high impedance and draws negligible current. Consequently, the compensating impedance may be considered the total effective burden across secondary winding 44 of current transformer 40.

Based on attributes of current transformer 40, such as turns ratio, core material, current, and burden, one skilled in the art can derive a ratio correction factor (RCF_{C}) and a phase angle error β of the compensating current, I_{C}. β represents a phase angle between load current I_{L} and compensation current I_{C}. This data can then be incorporated into determining an overall error of the metering voltage while power winding 28 is loaded.

$${I}_{C} = ( \frac{{N}_{C 1}}{{N}_{C 2}} ) {I}_{L} ( \frac{I}{{RCF}_{CT}} ) \qquad ( Eq . 17 )$$

Z_{C}=\sqrt{R_{C}²+X_{C}²} (Eq. 18)

V_{C}=I_{C}Z_{C} (Eq. 19)

Using phasor Eₘ as an X axis, compensation voltage V_{C} can be divided into X and Y components V_{X} and V_{Y}. V_{X} and V_{Y} are represented in FIG. 3. Eₘ represents the voltage across meter winding 26.

V_{X}=V_{C} cos(Θ_{C}−α_{C}), and (Eq. 20)

V_{Y}=V_{C} sin(Θ_{C}−α_{C}), (Eq. 21)

where α_{C}=Θ_{L}−β and

$${Θ}_{C} = arctan ( \frac{{X}_{C}}{{R}_{C}} ) .$$

To derive RCF_{C} while employing voltage compensator 20, one may calculate a magnitude of the metering voltage Vₘ.

Vₘ=\sqrt{(Eₘ+V_{X})²+V_{Y}²} (Eq. 22)

The RCF_{C} can then be provided by

RCF_{C}=(V₁/NR)/Vₘ. (Eq. 23)

Calculating the phase angle error in the presence of voltage compensator 20 will now be described. The phase angle error of compensated metering voltage Vₘ is a difference between angles αₘ and γ. Phase angle αₘ can be derived using the law of cosines.

$${V}_{C}^{2} = {V}_{m}^{2} + {E}_{m}^{2} - 2 {V}_{m} {E}_{m} cos {α}_{m} \\ 2 {V}_{m} {E}_{m} cos {α}_{m} = {V}_{m}^{2} + {E}_{m}^{2} - {V}_{C}^{2} \\ cos {α}_{m} = \frac{{V}_{m}^{2} + {E}_{m}^{2} - {V}_{C}^{2}}{2 {V}_{m} {E}_{m}} \\ {α}_{m} = arccos ( \frac{{V}_{m}^{2} + {E}_{m}^{2} - {V}_{C}^{2}}{2 {V}_{m} {E}_{m}} ) \qquad ( Eq . 24 )$$

γ_{C}=γ−αₘ (Eq. 25)

The phasor diagram shows how the compensation voltage V_{C} improves an accuracy of metering voltage Vₘ by aligning it with the theoretical ideal voltage V₁/N_{R} as compared to uncompensated voltage Eₘ.

What is claimed is:

1. A compensated voltage transformer, comprising:
a voltage transformer that includes
a primary winding that receives a supply voltage,
a meter winding that generates a first voltage based on a first turns ratio between the primary winding and the meter winding, and
a power winding that generates a second voltage based on a second turns ratio of the primary winding to the power winding; and
a current transformer that includes a primary winding and a secondary winding, wherein the primary winding carries a load current that flows through the power winding and the secondary winding connects to the meter winding.

2. The compensated voltage transformer of claim 1 further comprising a compensation impedance connected across the secondary winding, wherein the compensation impedance generates a compensation voltage that is summed with a meter voltage which is generated by the meter winding.

3. The compensated voltage transformer of claim 2 wherein the compensation impedance comprises a resistance and a reactance.

4. The compensated voltage transformer of claim 3 wherein the resistance and the reactance are connected in series.

5. The compensated voltage transformer of claim 2 wherein the compensation voltage is proportional to a voltage that is dropped by an impedance of the primary winding.

6. The compensated voltage transformer of claim 5 wherein the compensation voltage is equal to the voltage dropped by the impedance of the primary winding divided by a turns ratio of the primary winding to the meter winding.

7. A compensated voltage transformer, comprising:
a voltage transformer that includes
a primary winding that receives a supply voltage,
a meter winding that generates a first voltage based on a first turns ratio between the primary winding and the meter winding, and
a power winding that generates a second voltage based on a second turns ratio of the primary winding to the power winding;
a current transformer that includes a primary winding that connects to the power winding and a secondary winding that connects to the meter winding; and
a compensation impedance connected across the secondary winding, wherein the compensation impedance generates a voltage that is summed with the first voltage to provide a metering voltage.

8. The compensated voltage transformer of claim 7 wherein the compensation impedance comprises a resistance and a reactance.

9. The compensated voltage transformer of claim 8 wherein the resistance and the reactance are connected in series.

10. The compensated voltage transformer of claim 7 wherein the meter winding and the power winding have unequal numbers of turns.

11. A method of compensating a secondary voltage in a multi-secondary voltage transformer, comprising:
applying a supply voltage to a primary winding of a voltage transformer;
providing a load current to a load from a first secondary winding of the voltage transformer;
generating a first voltage across a second secondary winding of the voltage transformer;
transforming the load current to a second current;
generating a second voltage based on the second current; and
summing the first voltage and the second voltage to generate a meter voltage that is based on the supply voltage and the load current.

12. The method of claim 11 wherein generating the second voltage includes passing the second current through an impedance.

13. A compensation circuit for a multi-secondary voltage transformer, comprising:
a current transformer including
a primary winding for connecting to a first secondary winding of a multi-secondary voltage transformer; and
a secondary winding for connecting to second secondary winding of the multi-secondary voltage transformer; and
an impedance that conducts current of the current transformer secondary winding and thereby drops a compensation voltage, wherein the compensation voltage is proportional to a voltage drop of a primary winding of the multi-secondary voltage transformer.

14. The compensation circuit of claim 13 wherein the current transformer primary winding conducts a load current of the multi-secondary voltage transformer.

15. The compensation circuit of claim 13 wherein the compensation impedance comprises a resistance and a reactance.

16. The compensation circuit of claim 15 wherein the compensation impedance comprises a resistor and an inductor.
